(19) United States
(12) Patent Application Publication
(10) Pub. No.: US 2002/0105529 A1
(43) Pub. Date: Aug. 8, 2002

(54) Generation and display of multi-image video streams

(76) Inventors: Jason Bowser, Harrisburg, PA (US); Andrew Justice, Camp Hill, PA (US); Jason Carter, New Cumberland, PA (US)

Correspondence Address: James E. Eakin, McDermott, Will & Emery, 2700 Sand Hill Road, Menlo Park, CA, 94025, US

(21) Appl. No.: 09/782,466

(22) Filed: Feb. 9, 2001

Related U.S. Application Data
(60) Provisional application No. 60/181,803, filed on Feb. 11, 2000.
(60) Provisional application No. 60/210,228, filed on Jun. 6, 2000.
(60) Provisional application No. 60/260,913, filed on Jan. 10, 2001.

(51) Int. Cl. G09G 5/00

(52) U.S. Cl. 345/629

(57) ABSTRACT

A method is disclosed to capture and manipulate digital video images, and to display one or more of the images on a client system as a video stream, without the need for the client to use plug-in or other media player software. In an exemplary embodiment, the method includes capturing digital video images of a rotating object, relaying the digital data to a computer programmed to allow direct access to audio and video streams from the digital camera, without the need for intermediary programs. Subsequently, the digital video data is parsed to select images which are edited, processed and configured to be distributed for viewing as a video sequence within a browser window, without the need for a media player.

### FIELD OF THE INVENTION

The present invention relates generally to the capture and manipulation of images such as those of an object, and the subsequent display of one or more of those images on a client system as a video stream without the need for a media player, thus allowing a user to view the object.

### SUMMARY OF THE INVENTION

The present invention comprises multiple components for capturing, editing, and subsequently displaying video information about an object. A first portion of the invention includes method and apparatus for capturing images of an object, and can include a turntable on which an object of interest can be rotated together with a video or other suitable camera by which the rotated object can be viewed from multiple angles. The image data from the camera is captured in a computer system running a program which forms one aspect of the invention, from which a local computer operator can construct a plurality of images in any desired manner to represent the object of interest. A typical representation will be a full rotation of the object, thus providing views of the object from multiple sides in what is essentially a three-dimensional view of the object.

That plurality of images, which may be thought of as a “video clip” or a “virtual reality movie” or a flipbook of images, is then supplied—typically over a network such as the Internet—to one or more remote users to permit the remote user to view the plurality of images in a manner which affords the user the opportunity to examine the object from the various perspectives represented by the multiple images.

In an important portion of the invention, the assembled video clip is formatted to permit viewing of the video clip by the user without the need for a plug-in or other media player software, thus simplifying the download and increasing the potential viewing audience. A related portion of the invention involves the use of a rollover technique, typically although not necessarily controlled by a cursor control device such as a mouse, for selecting which of the multiple images is displayed, thus allowing the user to examine the object represented by the video clip.

To ensure proper usage of the system, including a means for appropriate revenue generation, a security aspect may be implemented by which a secure key is associated with each video clip generated by the local computer for subsequent distribution to a universe of users to view.

It can therefore be appreciated that the present invention has a video capture aspect, a video clip editing and assembly aspect, a video clip distribution aspect, a rollover aspect for permitting the remote user to control the display, and a security aspect. Each of these aspects may be used separately from the others, in at least some embodiments.

Referring again to the video capture and video clip editing aspects, in a first implementation the present invention includes method and apparatus for capturing digital video data or other information about the object. In a first preferred arrangement, the method and apparatus permits capturing a plurality of images representing a 360 degree exterior view of the object, although it is not required that the images represent exactly one full rotation or any rotation at all; instead, other motion may be captured depending on the application. In a presently preferred arrangement, the images are captured by a conventional digital video camera or camcorder. The digital video information is then sent to a computer, for example via a Firewire (IEEE 1394) interface, where the digital video information is captured and stored, at least temporarily, in any acceptable format, for example an AVI format, either interlaced or non-interlaced, MPEG, Quicktime, and so on.

To assist in the rapid capture of the incoming video information, in an exemplary embodiment the software of the present invention is written to interface directly to, for example, the DirectShow portion of the DirectX API from Microsoft although the particular API is unimportant. Alternatively, the software could be written directly to the OS (which need not be Windows, but instead could be the Macintosh OS, for example) rather than taking the more convenient route of using an API. The objective is to access directly the video capture, manipulation and display capabilities incorporated into the operating system.

In capturing the images which will comprise the video clip, the live feed video is captured by creating a filter graph in computer memory. The filter graph, which may be thought of as a process, funnels the most recent available frame of video from the feed (such as the camera) to a preview window. Then, a second filter graph writes the video data to an file on a storage medium such as a hard disk. Once the image data is captured, a third filter graph displays the captured image data on a screen.

The file, which may for example be in AVI format, may then be manipulated by any conventional video image processing tools such as those available from Adobe, Ulead, and others. The image processing software will allow selection of one or more of the frames from the incoming video and reassembly of the selected frames into a final sequence of images. In general, the video data is parsed into a series of digital still images from which specific ones are selected for further use. As an alternative to using a video camera, individual images may be selected from any image source such as a still frame camera, animations, drawings, or other images. The selected still frame images are typically then converted into an image format suitable for distribution over a network such as the Internet; one acceptable format is JPEG, although other formats (such as GIF, BMP, etc.) are acceptable depending on the amount of compression desired, bandwidth, network throughput, download time permitted and so on.

The selected digital still images are then assembled into a sequence of still frame images which, taken together, create a video-like sequence that may be thought of as a form of video clip or a “virtual reality movie”. As noted previously, one application of such a video clip is the display of a plurality of images of an object taken from different perspectives, so that the video clip effectively displays a complete rotation of the object, sufficient to give the user an impression of the object from all sides. The video clip may comprise a plurality of individual image files, for example a series of JPEG's, or it may comprise a single image (e.g., a single JPEG) file which includes a plurality of sub-images arranged in a line or other suitable configuration to permit a selected sub-image portion of the file to be viewed individually by appropriate software control. It may also be desirable to save a plurality of additional images to allow for editing at a later time; this may be thought of as a form of intermediate oversampling, but would not in most embodiments form part of the final video clip. The final video clip is typically also associated with or included in a computer program which defines window size, location, and other aspects related to the display of the video clip in a browser window on a remote user's system, as discussed below.

The final video clip is then released for storage on, for example, a server or another form of storage device. For example, a server will be appropriate for network distribution, while in the alternative optical or other storage media may be used, such as a CD- or DVD-based catalog, or other forms of local, LAN or WAN storage. If for network distribution, typically such a server stores a plurality of video clips of different objects, such as the inventory being offered by an e- commerce site, for viewing by their customers. The video clip may then be made available in a conventional manner for distribution over a network such as the Internet, with the ultimate objective of displaying the object on a user's computer screen as discussed below. As will be discussed further hereinafter, the video clip may also be included for storage in a database management system, for example a relational database management system such as those available from Oracle, Informix, Microsoft and others such as SQL-based RDBMS's. In addition, sound may be included with the file in at least some embodiments. It will be appreciated that a video clip with sound essentially comprises a “movie”.

Turning to the video distribution aspect of the present invention, it is desirable to ensure that the video clip is viewable by the largest audience. It is well understood in the industry that many users are reluctant to modify their personal computer systems, particularly when such modifications may require downloading files known as “plug-ins” or other files which serve as media players. As a result, the software for controlling distribution of the video clip is implemented in a manner which does not require the download of any media player or other software “plug-in” for the operating system running the remote user's computer. In a presently preferred embodiment, an HTML file is created which includes a JavaScript portion for displaying the sequence of images via a Web browser operating on a user's system. The video clip generated by the previously-discussed aspects of the invention is downloaded to the remote user, and the sequence of images is displayed in a window on the Web browser, where the window size and location is specified by the HTML code. The window may be a new window, or can display in the middle of other portions of the display such as text, tables, and so on.

In a related aspect of the invention, a rollover technique is provided by which the user is able to select which of the sequence of images is actually displayed in the browser window. In a presently preferred embodiment, a mouse, stylus or other pointing or cursor control device may be used to select the particular image displayed on the screen. In particular, the mouse may be moved over the browser window in which the image is displayed. In an exemplary arrangement, moving the mouse from left to right advances the sequence such that the first image appears when the mouse is at the left side of the window, the second image appears as the mouse moves to the right, and the last image appears as the mouse approaches the right side of the window. Moving the mouse right-to-left reverses the sequence; leaving the mouse in place displays the image associated with that location in the window. This arrangement provides for a fast display of the images and allows convenient user control of the displayed information. Other techniques for incrementing or decrementing the selection of the displayed frame or frames within the sequence may also be implemented, for example the arrow keys or any other key combination, a timer, or the movement of the cursor over a different portion of the screen. Although the presently preferred embodiment can be viewed without plug-ins, the present invention also permits compilation of image files which are compatible with other VR formats including QT, HotMedia and other applets. Such compatibility also provides compatibility with the associated wide range of compression codecs including BMP, Cinepak, component video, DV-NTSC, DV-PAL, graphics, H.261, H.263, motion JPEG A, motion JPEG B, photo JPEG, planar RGB, PNG, MPEG, among others.

In some applications, it may be desired to limit access to one or more elements of the system. In particular, it may be desirable to limit the ability of the local user to generate video clips in the manner described above. If this limitation is desired, as it might be if a charge is incurred for each video clip released to a server, for example, then it becomes appropriate to ensure that the software is used only on the appropriate computer system, and also to ensure that each issuance of a video clip has associated therewith an appropriate charge. While these may be implemented separately, the combination provides an effective and efficient way to ensure proper usage of the system.

To limit use of the software on an unauthorized system, the video data captured from the digital video camcorder or other video input device may be encrypted by any conventional algorithm using as a key, for example, the network address of a network card in the system, a unique MAC address, an electronic serial number from the computer or processor, or other suitably unique identifier. By checking for the appropriate key, the system can be limited to provide access to the captured video only through the specific licensed system. In addition, or in the alternative, the encryption key technique may also be used to ensure that the software operates only on the licensed system.

In an alternative arrangement, security may be provided from the server side through use of what is essentially a thin client with authentication. In such an arrangement, the keys may be stored on the server, and additional purchased keys can be added by cgi, perl or comparable script, or by manual entry. In an exemplary arrangement, when the application launches it prompts the user for a user ID and Password. These can be assigned by, for example, the server administrator, or dynamically from a password generation program. In one embodiment, the authentication can be created from, for example, the first four letters of the user's name and first four numbers of their phone number. The username and password can be emailed to them after they have registered for an account properly, and have successfully made provisions to open an image key account.

In such an embodiment, the client downloads the application after their email address has been authenticated. When the user launches the application, the application asks for the user name and password. This is needed to permit them to create the Javascript output or to render to HTML button in the application. Without a validation from the servers of a valid image key account, the software will not allow for the saving of finished VR files. When account information is successfully validated, the application reports status of the account (number of keys left, account name).

In this arrangement, the user is connected to the internet to permit authentication in an arrangement similar to a very thin client. The server application keeps track of licenses by decrementing one license for each time the “Render to HTML” button is depressed in the application. This is the final step in the application and after this button is depressed it sends the message “decrement 1 license” to the server using a Perl Script that communicates with our server via the IP address that executes the CGI script “decrement license.”

The keys may also be configured to expire at a given deadline, for example by attaching a “virus” to the image file which causes the file to be deleted automatically when the deadline date set by the author of the file matches the date and time established for comparison purposes, such as either a server date and time or local system date and time.

To ensure that a proper count is made of the video clips generated by the system, license keys may be used in combination with the encoded captured image file. For example, a license key may be required to issue a final video clip file for distribution. The video data file being edited may be encrypted in the manner described above. Following editing, the final version is ready for release but still encrypted. To decrypt the file, the user associates a license key with the file, which allows for its decryption and release for distribution. The license key information, or the encryption key information, or both, may be kept as part of the released file to ensure that each released file has a unique key associated therewith.

To facilitate operation of the editing system independent of any required connection to the network, the user may purchase a quantity of license keys in advance of use and the license keys may be stored in the local computer system (or, depending on the implementation, in the server) until needed. The keys are typically purchased in a network transaction, but no other connection to the Internet is typically required and the video clip generation process can proceed unimpeded, or even remotely or on location. In some embodiments an internet connection may be required for creating a final output file.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIGS. 1A-1D illustrates the basic arrangement of the capture portion of the present invention.

FIG. 2 illustrates in flow diagram form the steps in processing the sequence of images into a video clip.

FIGS. 3-6 illustrate the display of the images selected by the process of FIG. 2.

FIG. 7 illustrates the rollover technique of the present invention.

FIG. 8 illustrates the process by which an end user views the video clip using the rollover technique.

FIG. 9 illustrates in flow diagram form the security and encryption aspect of the present invention.

FIG. 10 illustrates a web-layering technique in accordance with the present invention.

FIG. 11 illustrates the use of buttons for controlling virtual rotation, as an alternative to the rollover technique of the present invention.

FIG. 12 illustrates in flow diagram form an aspect of invention whereby image files may be included in RDBMS's.

Whenever possible, the same reference numbers will be used throughout the Figures to refer to the same parts.

### DETAILED DESCRIPTION OF THE PREFERRED EMBODIMENTS

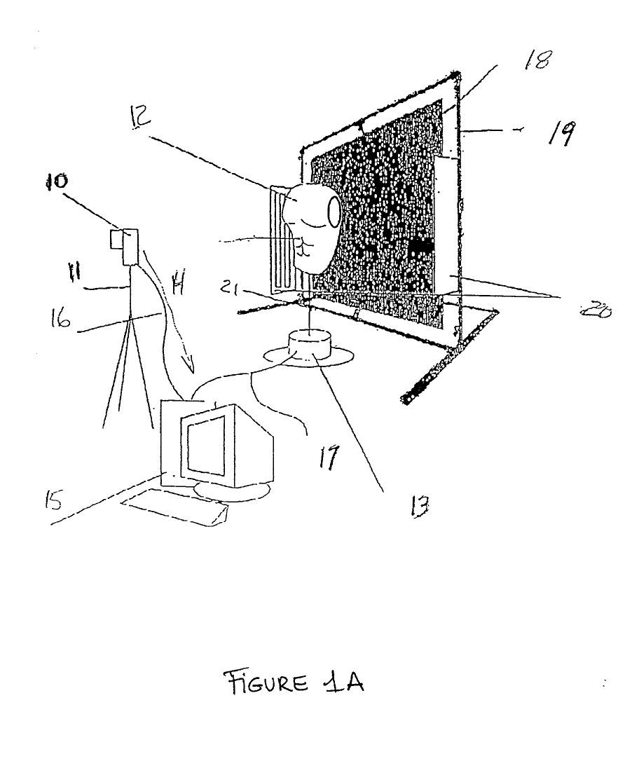

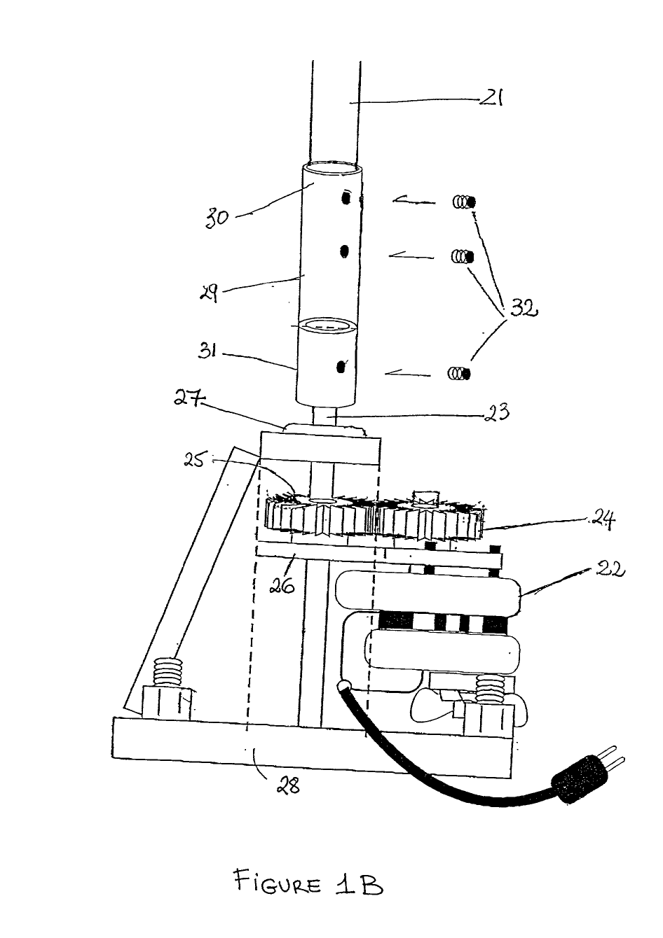

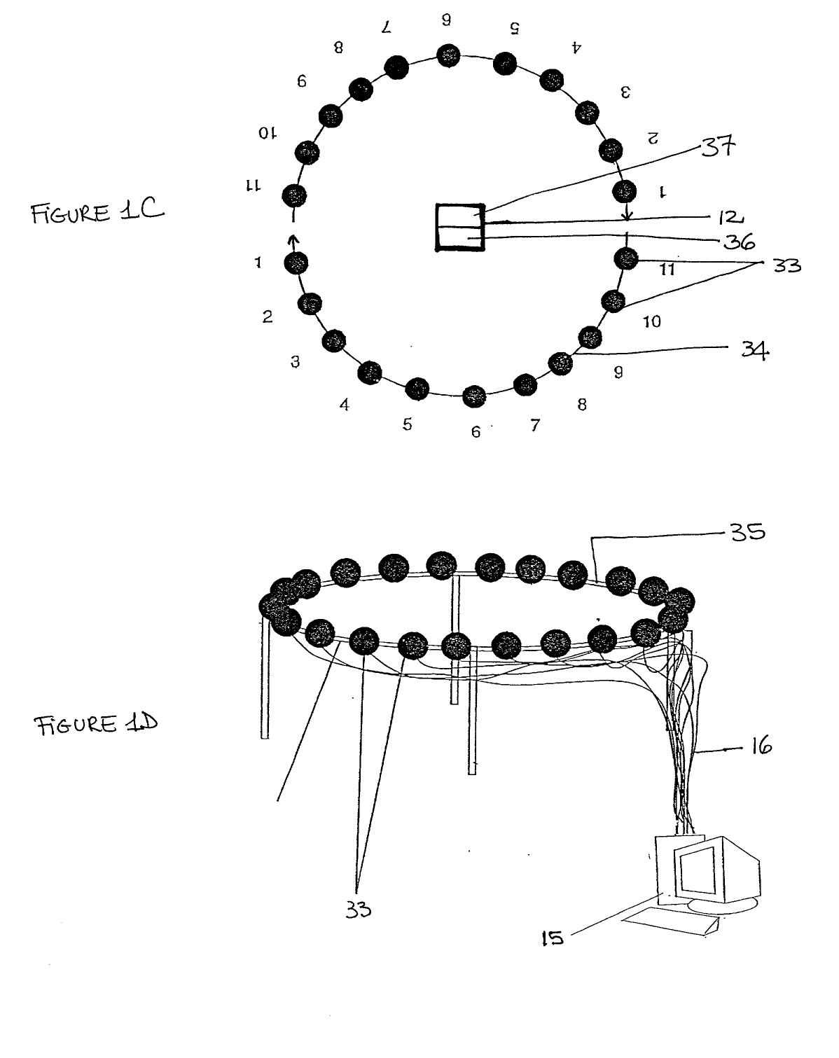

FIG. 1A illustrates an exemplary embodiment of a basic system for capturing a video image stream of an object under observation. A digital video camera 10, which may be mounted on a tripod 11 or other suitable support, is focused on an object of interest 12. In the exemplary arrangement, the object 12 is mounted atop a turntable device 13 which permits the object 12 to be rotated. In this instance, the object 12 is better seen when supported on a post 21 mounted from the turntable. As the object rotates, the digital video camera 10 sends a video data stream 14 to a capture and editing computer system 15. In one possible arrangement, the operation of the turntable and the camera are both controlled from the computer 15, such that rotation of the turntable 13 is queued according to the operation of the camera 10. The video data stream 14 represents video of the object that may be captured at, for example, the NTSC video standard of 30 frames per second (fps). However, the video of the object can be captured at different frame rates that vary from, for example, 1 fps to 90 fps. In another possible embodiment of the present invention, the digital video data could include a series of digital still images (from a still camera, a computer simulation, animation, drawings, or any other image source) of the object which are stitched together to simulate a video stream. It will also be appreciated that, in many arrangements, the images captured may not represent a rotation of the object, but may instead represent other motion. In such instances, a turntable is not used and the images from which the video data is constructed may be obtained from any suitable source of images. Among other options, it is possible in a related aspect of the invention to convert other file formats to the format typically used herein. For example, existing Quicktime, animated GIF, Java Applet, or other files may be converted into a format suitable for use in the process of the present invention.

FIG. 1B shows that the rotation of the turntable device may achieved by the driving force of a motor 22, such as a 1.2 A subfractional motor operating on 110V AC power. The post 21 is arranged on a turntable shaft 23 and rotated by the driving force of the motor 22 at a speed specified by the ratio of two gears 24 and 25. Typically, a speed of between 0.1 and 15 revolutions per minute is chosen to allow for the capture of undistorted images of the object. The turntable device is stabilized by a support element 26 and bearings 27, and the entire structure is firmly secured to a base 28. The object post 21 is connected to the turntable shaft 23 by means of a shaft collar 29. The upper 30 and lower 31 ends of the collar 29 are shaped and sized to provide a tight fit with the post and turntable shaft ends, respectively, and this connection is firmly secured by screws 32, or other fastening means. Shaft collars may be made of any inflexible material which is suitable to support the object, and to maintain contininuous and smooth rotation of the post 21.

FIGS. 1C and 1D illustrate alternative embodiments of the system to simultaneously capture multiple video images of a stationary object. In these arrangements, the object 12 is placed equidistant from two or more cameras 33 that are mounted on a semicircular 34 or circular 35 frame. In the exemplary arrangement shown in FIG. 1C, eleven cameras are positioned on the semicircular frame 34 to capture images of the front portion of the object 36. Subsequently, the frame may be rotated 180° to capture images of the rear portion of the object 37, thereby compiling a set of images that represent a 360° view of the object. Simulatneous capture of all 22 images may be obtained by surrounding the object 12 with 22 cameras 33 mounted on the circular frame 35, as shown in FIG. 1D. The image data from each of the cameras may be stored in the camera, or each camera may be modified to relay the data to the computer 15 via a cable 16, as described below.

Returning to the exemplary embodiment, the video data stream 14 is typically transmitted from the camera to the computer by any suitable means, for example a Firewire (IEEE 1394) or similar cable 16, although RF and infrared communications schemes are possible as are other cable-based protocols such as Zoomed Video, USB or USB2, s-video, RCA cables, and so on. If wireless communication is used, any suitable frequency which provides adequate reliability and throughput is acceptable, including ISM or other Gigahertz bands as well as more conventional RF bands. Additionally, the information transferred between the digital video camera 10 and the computer 12, whether wirelessly or over cable 16 could employ broadband technology, wideband technology or other similar type of transmission techniques.

For ease of understanding, the discussion hereinafter will assume the use of a Firewire connection between the camera 10, which will be assumed for convenience to be a digital video camera, and the computer 15, but such description is by way of example only and is not intended to be limiting. A Firewire connection allows data transmission from the camera to the computer, but also allows transmission of camera control signals such as start, stop, zoom in or out, etc., from the computer to the camera. Of course, it will be appreciated that a camcorder can be used to store the video data on tape for later download to the computer system 15, which may for some rudimentary embodiments eliminate altogether the need for the cable 16 at the time the video data is collected. The turntable, if used, may be controlled from the computer by means of a conventional cable 17 such as an RS-232, parallel, USB, or other similar connection; wireless connections are also easily implemented since the primary objective of communication between the computer and the turntable is simply the starting, stopping and varying the speed of rotation; indexing may also be desired. As with the cable 16, the cable 17 may be eliminated in some rudimentary embodiments, in which case the rotation of the turntable is controlled manually. In more sophisticated embodiments, the computer is able to communicate with the turntable to provide indexing and the related control functions mentioned above.

The object 12 may be disposed before a backdrop 18 mounted on a suitable frame or other structure 19, and appropriate lighting 20 may also be provided. In some instances, the object 12 may be better seen if it is supported on a post 21 mounted from the turntable 13. The backdrop 18 is typically although not necessarily a solid color such as blue or other good contrast to the object 12, which facilitates not only file compression but also matting of alternative backgrounds during the editing process discussed hereinafter. In some instances it may be desirable to include logos, trademarks or other legends on the background for simplified keying and filtering. Of course, in other instances it may be desirable not to use a backdrop or lighting at all, although this may create additional issues during editing and may lead to increased file sizes.

The digital video camera 10 may be mounted on any stable platform such as a tripod 41 or other suitable device for holding the digital video camera 10 in a relatively fixed position. As the object rotates, the digital video camera 10 transmits the corresponding digital video data over cable 16 to a computer 12. The cable 16 is preferably connected to a standard port on the computer such as a Firewire (IEEE 1394) port, a parallel port, a serial port, video port or USB port, however, the cable 16 could also be connected to a zoomed video (ZV) port and ZV card. The cable 16 is, in an exemplary embodiment, a Firewire (IEEE 1394) cable, but could be an s-video cable, USB cable or any other type of cable suitable for transmitting digital video data and compatible with the associated computer port. In one possible embodiment of the present invention, the cable 16 could also be used by the computer 12 to transmit commands such as start, stop, focus, zoom in or out and other camera controls, to the digital video camera 10, although for some protocols a separate cable is needed for these functions.

In another possible embodiment of the present invention, the digital video data captured by the digital video camera 10 could be stored in a portable storage medium readable by the computer 15 such as an external hard drive, optical disk, floppy diskette, memory card, PCMCIA/PC flash card or drive, or memory chip and then be subsequently transferred to the computer 15 at a later time for processing by the computer 15 into the video clip.

The computer 15 can be any type of general purpose computer properly configured to be able to receive and manipulate digital video data, and may for example be a WINTEL-compatible personal computer operating at a suitable clock speed to accommodate video capture and editing, with sufficient disk storage space and adequate RAM for such functions. Such a computer 15 includes devices for inputting information such as a mouse or other pointing device, and a keyboard, and typically includes additional I/O ports for receiving electronic information, e.g., Firewire, optical, serial, parallel, and/or USB interfaces, among others. The computer 15 typically also includes devices for outputting information such as a computer monitor or display screen, printers and ports for transmitting electronic information such as Firewire, optical, ultrawide SCSI, USB and so on. The computer 15 will then process the digital video data received from the digital video camera 10 into the video clip of the object 12 in accordance with the commands of the operator, as described in greater detail below.

In an exemplary embodiment, the capturing of video data 14 is accomplished as follows: the object 12 is first placed on either the turntable 13 or the mounting post 21, in front of the backdrop 18 and with appropriate lighting from the lights 20. The digital video camera 10 is then placed in a position where the object 12 is located within the field of view of the camera 10. The computer starts the turntable 13 rotating via the cable 17 at a preselected speed appropriate for the video capture process. The digital video camera 10 is correspondingly started, although not necessarily at the exact same time, to start transmitting digital video of the object to the computer 15. The speed of rotation of the object and the rate of capturing the digital video are preselected so as to provide a smooth and undistorted image. The computer 15 can display the digital video to the user as it is captured by the captured at the computer 15. Any desired amount of rotation can be specified, including more, less or exactly 360 degrees. For many applications, a single rotation is adequate. After the desired amount of rotation, and the capture of the corresponding video data, the turntable and the camera may be stopped.

To facilitate rapid video capture, an exemplary embodiment of the present invention includes a computer program which writes to the DirectX 7.0a API from Microsoft, and in particular the DirectShow portion of the DirectX API. The DirectX API allows direct access to audio and video streams from any Digital Video cameras attached to the computer. By writing the program to the DirectX API, Apple's Quicktime API, or another suitable API, the need for separate video software such as Windows Media Player is obviated. The video capture and manipulation functions built into the operating system are exposed directly by the API, and so can be used without intermediary programs. The live video feed from the camera 10 is processed in the computer 15 by using the DirectX API to create a process in memory (a first so-called filter graph) that constantly funnels the most recent available frame of video from the DV camera to a preview window in the application. The video capture is performed by a second filter graph that writes the video data to an AVI-format file on the hard disk as quickly as possible while updating the screen with current video data in its free time. The video playback is managed via a third filter graph that reads video data from an AVI-format file on the hard disk and displays it on the screen for review and editing.

When the captured video is acceptable, the next step is to generate the VR Preview. The user is prompted for the number of frames and JPEG quality. The number of frames represents how many images will be in the final 3D image. The greater the number of images, the smoother the 3D animation will appear. However, the greater number of images the larger the file size will be for the final 3D image. The same goes for JPEG quality. The greater the JPEG quality the better clarity the image will have. The better the image quality the larger the file size. If the 3D images are to be posted to the Internet, download speed for end-users may be more important than image animation smoothness and quality; but a CDROM-based presentation may require quality more than speed. When the software completes processing the images, a preview of the final VR will appear in a designated portion of the application window. Moving the cursor over the preview image cause the object to spin exactly as the final 3D image will in a web browser. The clip may then be rendered, or edited further.

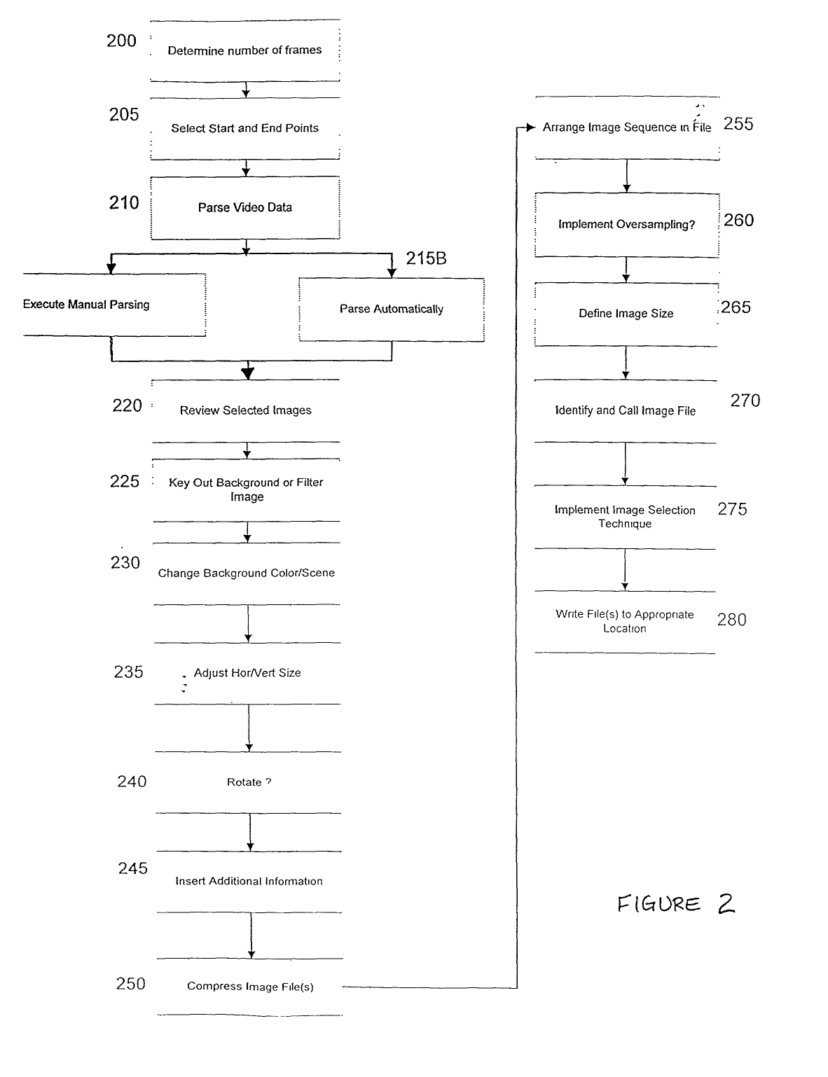

Referring next to FIG. 2, the process for developing the sequence of images which will end up as a video clip can be more fully appreciated. First, at step 200, a determination is made of how many different images or frames are to be used to make up the movie. The number of images used in the sequence can vary from two images up to as many images or frames as the user/developer wants to include in the movie. Next, shown at step 205, a starting point and an ending point in the digital video is selected. The starting point and ending point could each be a particular frame or the starting point and ending point could be elapsed times in the digital video. Typically, the starting and ending points of the digital video are selected as the beginning and ending points to be used, such as the beginning and ending of a full rotation of the object 12.

After determining the number of images to be used and the starting and ending points, the digital video data is parsed to select the images or frames to be used in the movie, as shown at step 210. In the simplest arrangement, the editor could manually parse the digital video data to select the desired images to be included in the movie, as shown at step 215A. Alternatively, and presently preferred, the computer 15 is be programmed (as shown at step 215B) to select images based on the amount of digital video data received, including the starting points and ending points of the digital video, and the number of images or frames needed for the movie. The computer 15 can be programmed to select the images or frames at approximately equal intervals. The intervals can be determined by taking the total time of the digital video and dividing the time by the number of images or frames needed. For example, if the digital video that was captured was 15 seconds long and the user requested 6 frames, the images for the movie would be taken every 2.5 seconds starting from the starting point. The interval could also be determined by taking the number frames captured and dividing that by the number of images or frames required. The images selected by the computer 15 can then be reviewed by the editor to check for the appropriateness of the images, as shown at step 220.

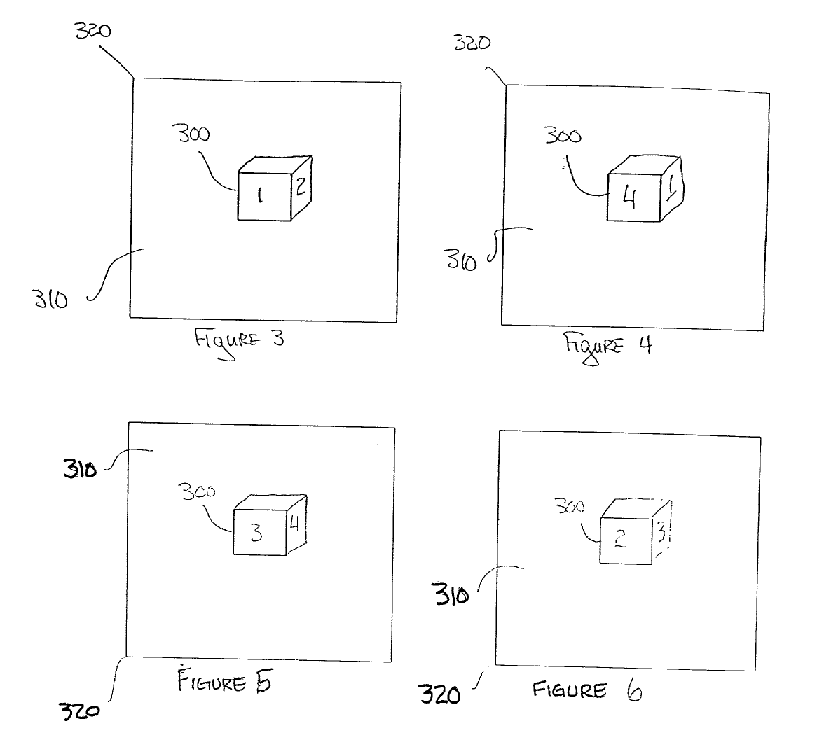

Referring next to FIGS. 3 through 6, the image sequence which results from the process shown in FIG. 2 may be better appreciated. If a sequence of four frames is selected at step 200, with a decision at step 205 to begin and end with a full rotation, then the digital video will be parsed into the images shown in FIGS. 3 through 6 are representative of the sequence of images which comprise the final video clip. As shown in FIG. 3, the object of interest 300 is shown at a first angle of rotation within a window 310 on a display 320. In FIG. 4, the object 300 has rotated approximately ninety degrees relative to FIG. 3, while in FIG. 5 the object has rotated approximately one-hundred-eighty degrees. In FIG. 6 the object has rotated two-hundred-seventy degrees. Thus, a full rotation of the object results from displaying the sequence of FIGS. 3-4-5-6-3.

If the editor is not satisfied with the images selected by the computer 15 for inclusion in the movie, the user can capture a digital video of the object and have the computer 15 calculate new images for the movie based on the new digital video. The user could also individually replace images selected by the computer 15 with neighboring or substitute images. As previously noted, as well, the images may be selected to depict other than a rotation of an object; and may, for example, depict other forms of motion or animation of an object or a view. The use of a rotating object is discussed herein solely as an exemplary embodiment, for purposes of simplicity to aid in understanding.

Once the images are selected for inclusion in the movie, the computer 15 can perform further processing steps on the images or frames, also shown in FIG. 2. The selected images can have any background keyed or filtered out of the image leaving only an image having the object, as shown at step 225. The background could also be changed in the image to a different color or scene, shown at step 230. Further processing on the images could include adjusting the vertical or horizontal display, cropping the image or resizing the image, as shown at step 235. Additionally, the image could be rotated in 90 degree intervals to provide the developer with different ways of viewing the image, shown at step 240. At this time the developer could insert additional information or text into the images, shown at step 245. Some examples of additional information that could be inserted are a time stamp, a date stamp, a company/manufacturer name, an inventory number, product information, such as name, price and identification number, general notes about the image or object or any other similar type of useful information. The additional information could be displayed in the movie and/or the additional information could be included in the file for use by the developer of the movie to learn more about the image and the object shown in the image.

In at least some embodiments, it may be desirable to integrate XML or other tags into the video files for the additional information, which would permit the video clips to be searched in an appropriate system. In an example of such an arrangement, a XML or similar data field is defined as part of the meta tag portion of the HTML (or other) code of the “movie”. The data field may be provided by text entry, bar code scan, or any other desired method. The data field may comprise any useful information about the item, including SKU #, color, size, price, manufacturer, or other descriptive information. The data field thus permits the video clip to be searched by any suitable method, including various database management schemes. Such database schemes will be discussed further hereinafter.

After all processing has been completed the images are typically, although not necessarily, compressed to reduce file size and thereby permit faster downloads that can be executed quickly and efficiently, as shown at step 250. The compression techniques used to compress the images could be any conventional compression technique. For example, the images could be compressed using algorithms that comply with the JPEG format, GIF format, PNG format or MPEG format. After the images are compressed, the compressed images can be saved into individual files identifying the format used to compress the images. However, the images do not have to be compressed before they are saved into the image files. If the images are not compressed the file sizes of the stored images will be larger, thereby making the size of the movie larger but with somewhat higher resolution. The use of uncompressed images in the movie can provide a more detailed resolution because no digital video information is lost in a compression step. The trade off for the more detailed resolution is that more storage space is required because of larger files and also possibly slower execution time for the movie due to the use of larger image files. Some examples of image formats that can be used to save the uncompressed images into files are tiff, targa, pict, eps, bmp, gif, psd or any other similar type of image file format.

At this point the editor/developer of the video clip has a series of images which represent the object of interest. To complete the process, the images must be configured in a manner which permits a user on a remote system to view those images as a video sequence. To do so, the images must be arranged in a file which permits a sequential display of those images, as shown at step 255 of FIG. 2. The video clip may comprise a plurality of individual image files, for example a series of JPEG's, or it may comprise a single image (e.g., a single JPEG) file which includes a plurality of sub-images arranged in a line or other suitable configuration to permit a selected sub-image portion of the file to be viewed individually by appropriate software control. In some embodiments it may also be desirable to implement an oversampling technique (shown at step 260), whereby a plurality of additional images is saved along with those selected for the final video clip, to allow for editing at a later time. This reduces the likelihood that a reshoot will be required, reducing both time and cost for creating secondary or follow-on video clips from the same initial session.

Several additional steps must be taken to complete a video clip suitable for distribution for viewing within a browser window on a remote user's computer system, as also shown in FIG. 2. In addition to the image file, appropriate computer program instructions must be generated to define image size (shown at step 265), to identify and call the image file (shown at step 270 and used only if the image file is not either concatenated with or embedded in the program), to provide a method for selecting which of the images to display (shown at step 275 and discussed in greater detail hereinafter), and so on. Finally, in an exemplary embodiment, the computer program of the present invention for writing video clips writes the image file or files into a directory for later distribution, as well as the main program and associated routines for displaying the video clip, all as shown at step 280. The main program and associated routines are typically also stored in the folder with the image.

In another feature of the invention, in some embodiments the images may be saved in an intermediate file format prior to generating the final output. The intermediate file may comprise a proprietary format which is not viewable with conventional browsers, but is instead viewed with appropriate translation software. The viewer software can be provided to any necessary step in the authoring process, including clients and third parties, to permit previewing of the intermediate file for purposes of finalizing the file for publication.

Although the general steps for generating the main program are shown in FIG. 2, if the movie is to be displayed on the Internet or World Wide Web, the main program may, for example, be written in HTML code and the routines may, for example, be written in JavaScript. This use of HTML and JavaScript for displaying the program images permits the movie to be displayed on web browsers such as Netscape Navigator and Microsoft Internet Explorer without the need for any additional plug-in software for the web browser. Alternately, the main program and program routines could be in other languages, such as Java, C, C++ or Visual Basic. Also, the video clips can be displayed in other contexts besides the Internet, and could be incorporated into other software that is distributed by portable computer readable mediums for use on any computer.

The exemplary use of the HTML and JavaScript code allows the movie to be user controlled and displayed in a web page without the use of a plug-in or Java applet. The JavaScript code may be kept in a protected file separate from the file with the HTML code. Table 1, below, is an example of pseudocode listing of HTML, shown in brackets (< >), and JavaScript that is used to generate the video clip, and results from the processing steps shown generally in FIG. 2. The code of Table 1 is intended to display a video clip file called “Alicia” which comprises a sequence of ten images of an object showing the object rotating approximately 360 degrees. The images in the sequence are assigned the names aliciasport01 through aliciasport19. In addition, the code establishes an association between a portion of the window in which the images is displayed and an individual one in the series of images. This aspect is particularly related to a mouseover technique, described further hereinafter, which permits the user to control which of the sequence is images is displayed in the window—without any plug-in or other program download. The table has been set forth with line numbers in parentheses; these line numbers are for reference only and form no part of the code. Also, individual lines of code which span more than a single line of text have been spaced apart below for clarity.

TABLE 1

| | |
|---|---|
| (1) | <HTML> |
| (2) | <HEAD> |
| (3A) | <meta META NAME=“description” CONTENT=“aliciasport”> |
| | <META NAME=“KEYWORDS” CONTENT=“large, red, hooded, |
| | sweatshirt, sport, sportswear, womens”> |
| (3) | <TITLE>Alicia</TITLE> |
| (4) | <SCRIPT LANGUAGE=“JavaScript”> |
| (5) | aliciasport01 = new Image; |
| (6) | aliciasport01.src = “aliciasport01.jpg”; |
| (7) | aliciasport03 = new Image; |
| (8) | aliciasport03.src = “aliciasport03.jpg”; |
| (9) | aliciasport05 = new Image; |
| (10) | aliciasport05.src = “aliciasport05.jpg”; |
| (11) | aliciasport07 = new Image; |
| (12) | aliciasport07.src = “aliciasport07.jpg”; |
| (13) | aliciasport09 = new Image; |
| (14) | aliciasport09.src = “aliciasport09.jpg”; |
| (15) | aliciasport11 = new Image; |
| (16) | aliciasport11.src = “aliciasport11.jpg”; |
| (17) | aliciasport13 = new Image; |
| (18) | aliciasport13.src = “aliciasport13.jpg”; |
| (19) | aliciasport15 = new Image; |
| (20) | aliciasport15.src = “aliciasport15.jpg”; |
| (21) | aliciasport17 = new Image; |
| (22) | aliciasport17.src = “aliciasport17.jpg”; |
| (23) | aliciasport19 = new Image; |
| (24) | aliciasport19.src = “aliciasport19.jpg”; |
| (25) | function hiLite(imgDocID,imgObjName) { |
| | document.images[imgDocID].src = eval(imgObjName + “.src”)} |
| (26) | </SCRIPT> |
| (27) | </HEAD> |
| (28) | <MAP NAME=“VR”> |
| (29) | <AREA SHAPE=“rect” COORDS=“0,0,16,300” HREF=“#” |
| | ONMOUSEOVER=“hiLite(‘Alicia’,‘aliciasport01’)”> |
| (30) | <AREA SHAPE=“rect” COORDS=“17,0,32,300” HREF=“#” |
| | ONMOUSEOVER=“hiLite(‘Alicia’,‘aliciasport03’)”> |
| (31) | <AREA SHAPE=“rect” COORDS=“33,0,48,300” HREF=“#” |
| | ONMOUSEOVER=“hiLite(‘Alicia’,‘aliciasport05’)”> |
| (32) | <AREA SHAPE=“rect” COORDS=“49,0,64,300” HREF=“#” |
| | ONMOUSEOVER=“hiLite(‘Alicia’,‘aliciasport07’)”> |
| (33) | <AREA SHAPE=“rect” COORDS=“65,0,80,300” HREF=“#” |
| | ONMOUSEOVER=“hiLite(‘Alicia’,‘aliciasport09’)”> |
| (34) | <AREA SHAPE=“rect” COORDS=“81,0,96,300” HREF=“#” |
| | ONMOUSEOVER=“hiLite(‘Alicia’,‘aliciasport11’)”> |
| (35) | <AREA SHAPE=“rect” COORDS=“97,0,112,300” HREF=“#” |
| | ONMOUSEOVER=“hiLite(‘Alicia’,‘aliciasport13’)”> |
| (36) | <AREA SHAPE=“rect” COORDS=“113,0,128,300” HREF=“#” |
| | ONMOUSEOVER=“hiLite(‘Alicia’,‘aliciasport15’)”> |
| (37) | <AREA SHAPE=“rect” COORDS=“129,0,144,300” HREF=“#” |
| | ONMOUSEOVER=“hiLite(‘Alicia’,‘aliciasport17’)”> |
| (38) | <AREA SHAPE=“rect” COORDS=“145,0,160,300” HREF=“#” |
| | ONMOUSEOVER=“hiLite(‘Alicia’,‘aliciasport19’)”> |
| (39) | </MAP> |
| (40) | <BODY TOPMARGIN=“0” LEFTMARGIN=“0” |
| | BOTTOMMARGIN=“0” RIGHTMARGIN=“0” MARGINWIDTH=“0” |
| | MARGINHEIGHT=“0” BGCOLOR=“#FFFFFF”> |
| (41) | <IMG SRC=“aliciasport01.jpg” WIDTH=“160” HEIGHT=“300” |
| | BORDER=“0” NAME=“Alicia” ALT=“” HSPACE=“0” VSPACE=“0” |
| | ISMAP USEMAP=“#VR”> |
| (42) | </BODY> |
| (43) | </HTML> |

End Table 1

Referring to the above code listings by line number, lines (1), (2) and (3) merely set up the HTML code and identify the title of the window in which the video clip will be displayed. Line (3A) provides the meta data for the file. Line (4) is an HTML command which tells the web browser that there is an external JavaScript file to be included into this location in the HTML code. Lines (5) designates in JavaScript the name of a variable, aliciasport01, and tells the script that the variable aliciasport01 is an image; line (6) then provides the source of that image, which forms the first of the images of the video clip, or aliciasportol.jpg. Lines (5) and (6) can thus be seen to form a pair; similarly, lines (6) and (7) through lines (23) and (24) can be seen to form pairs which define the associated variable as an image, and then tell where the source is for that image.

Line (25) starts a “hiLite” function and defines the variables imgDocID and ImgObjName, and then sets forth an evaluation routine using the two variables to change a selected image from its current image to a new image. In the exemplary code shown, imgDocID, the first variable, is defined as the name of an image to be changed, while the second variable, ImgObjName, designates the name of the new image which replaces the existing image. Line (25) identifies the end of the JavaScript portion, while line (26) ends the header portion of the code in which the JavaScript code was embedded.

Line (28) is HTML code which starts an image map in the browser for an image that uses it, and the “name” attribute contains the name of the map (in this case “VR”) as it will be called from the image tag that uses it. In addition, the map contains coordinates for “hot spots” that signal (through a window event such as the mouse moving the cursor over the hot spot) the JavaScript code to change the image. Lines (29) through (38) then designate the coordinates within an image to be used as a hot spot to initiate a window event designated “onmouseover” in the exemplary code. The occurrence of the window event signals the JavaScript code to execute the hiLite function discussed from line (25) and give that function the two values it will use. Thus, if an image map is 160 pixels by 300 pixels in its entirety, line (29) defines a rectangular portion of the image map with one corner at coordinates “0,0” and a diagonally opposed corner at coordinates “16,300”, and associates that portion of the image map with the image aliciasport01. Therefore, when the mouse or other triggering event is locating over the rectangular portion of the image map defined by the coordinates “0,0” and “16,300”, the first image aliciasport01 will be displayed. Line 30 defines the coordinates for the image aliciasportO3 to be “17,0” and “32,300”, and this paradigm continues until the coordinates for the last image, aliciasport19, are “145,0” and “160,300”. Thus, the image map is divided into ten rectangles, and associated with each of those rectangles is one of the ten images which makes up the video clip “Alicia”.

Line (39) defines the map, which in conjunction with line (40) sets the margins of the image map and the margin widths (in this case both zero), and also sets the background color for the image map, which is designated in hexadecimal notation. Line (41) is an HTML image tag which loads the defined image, in this case aliciasport01, into the designated window having width and height of, in this example, 160 by 300 pixels. The “NAME” attribute will be sent to the JavaScript code when it looks for the image to be changed, as seen in lines (29) through (38), with the “USEMAP” attribute specifying the image map from line (28) and telling the web browser to use the hot spots associated with that image map to change the images.

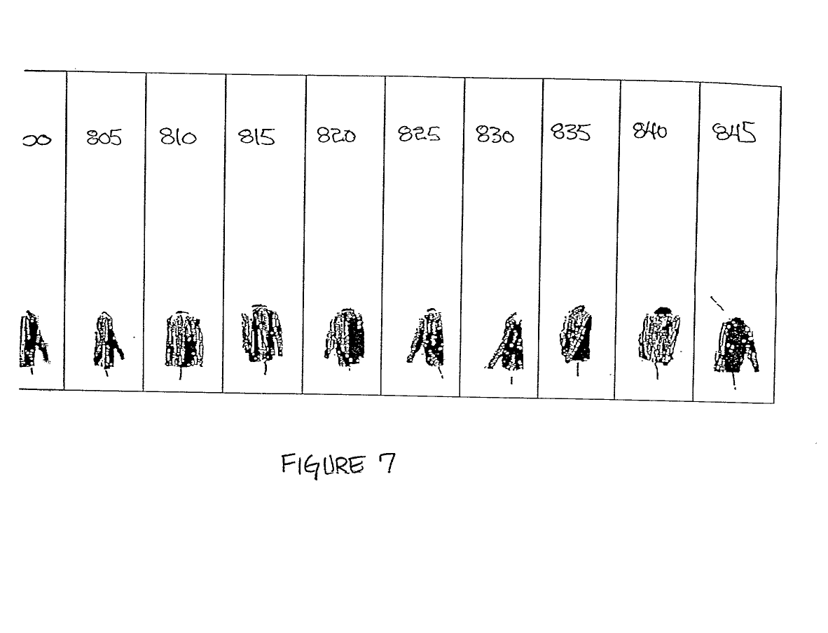

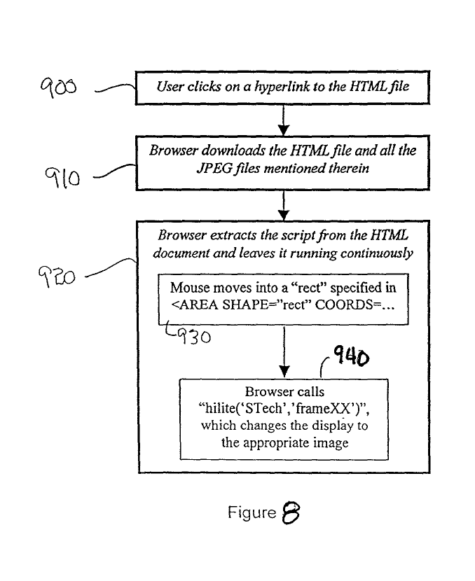

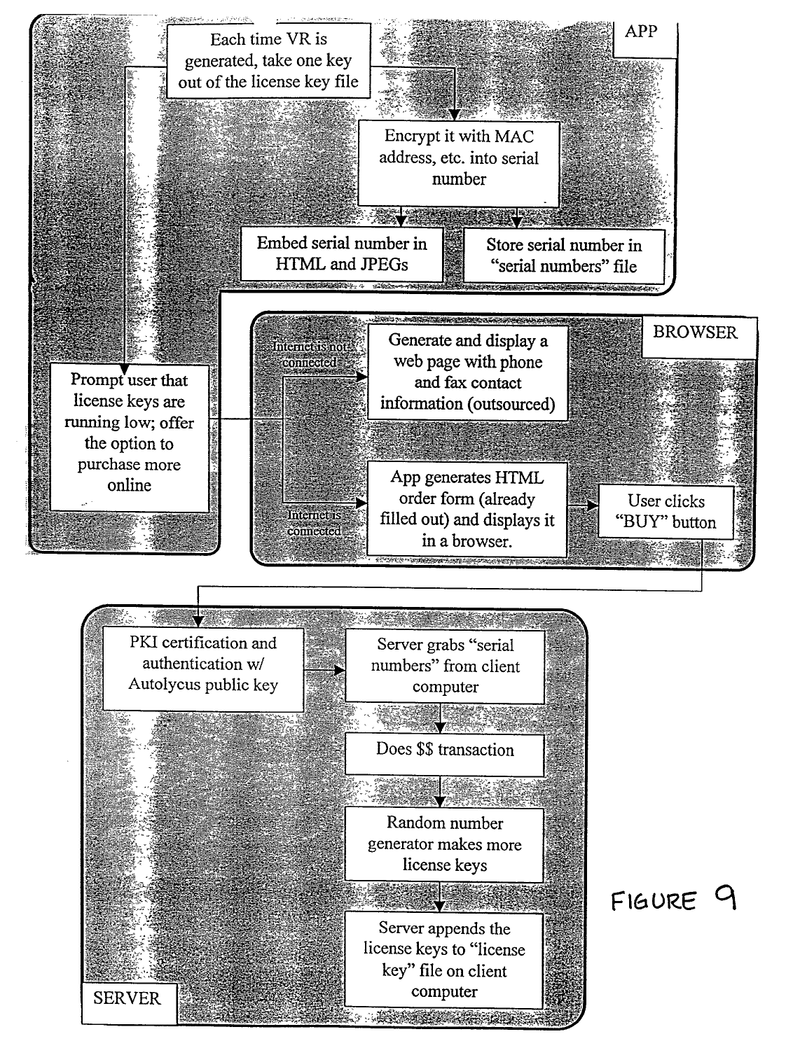

Given that the image map is divided into ten rectangles, moving the cursor (or if not the cursor whatever triggering event has been selected) over a given rectangle causes the image to be changed from the prior image to the image associated with the given rectangle. Since the images are sequential in this example, with each image representing an incremental rotation, the image will appear to rotate simply by moving the mouse from left to right across the image map displayed in the browser window. In this example, moving the mouse from left to right will cause rotation in a first direction, while moving the mouse from right to left will cause rotation in the opposite direction. This technique of dividing the image map into multiple zones and associating each zone with a particular image in the video clip may be thought of as a rollover technique, and is illustrated in FIG. 7. The zones, separated at the coordinates specified for each video clip—in this example ten zones B can be seen at reference numerals 800, 805, 810, 815, 820, 825, 830, 835, 840 and 845. Associated with each zone is the image from the video clip, such that all of the images represent the full range of movement of the object, in this example through a 360 degree rotation. Although movement of the mouse is used in the present example, and represents perhaps the most convenient way of signaling the code to change images, the rollover technique includes the option of using any form of signaling event.

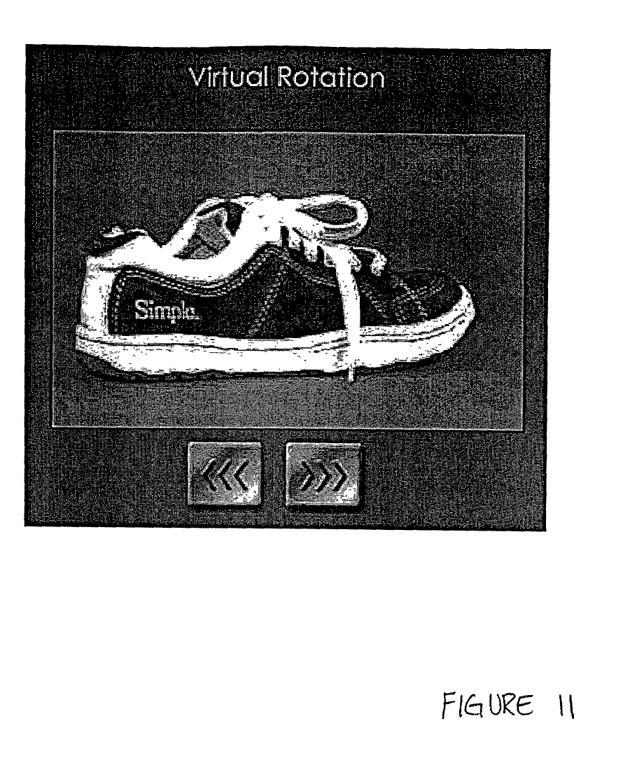

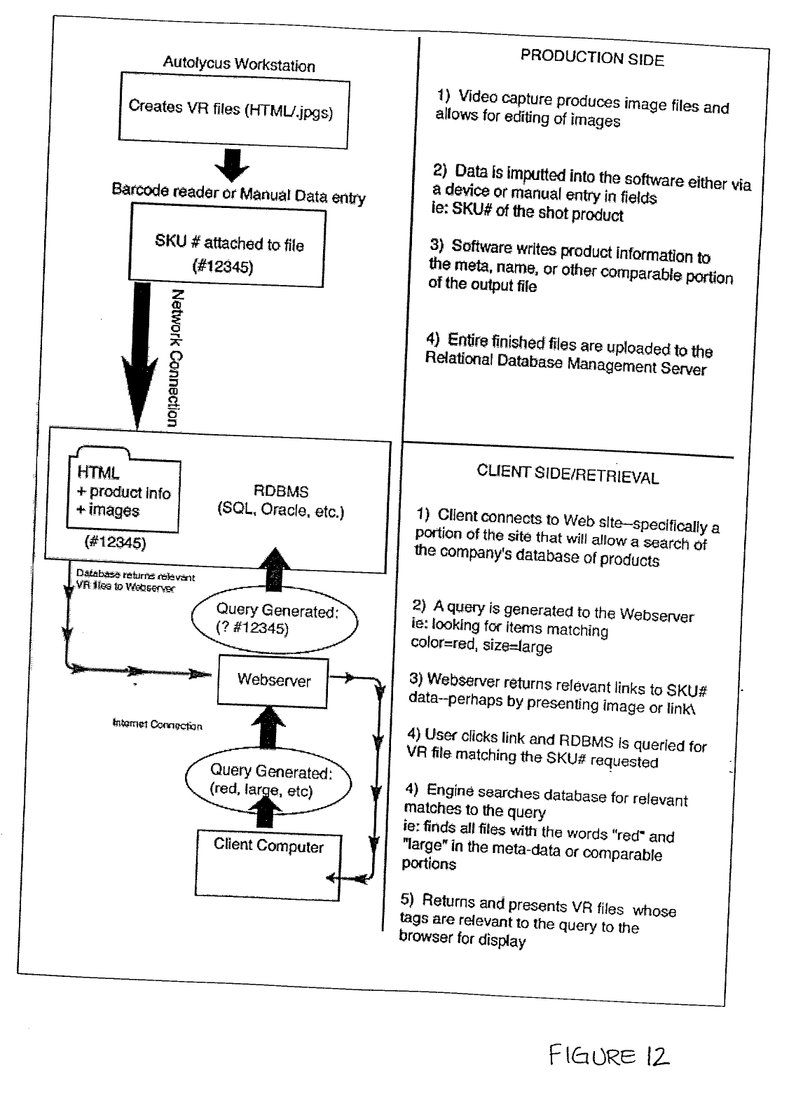

Another form of triggering event can include the use of Web layers, wherein a layer is used to display the user-controlled files (see FIG. 10.) By such an approach, the movie or video clip can be positioned anywhere on the page, such as above text or other image content, and the hotspots for activating the rollover are expanded to cover the entire width of the window, rather than just the image size which is typically smaller than the active window. Further, the video map can be configured to permit a slide show presentation rather than the rollover technique; in such an arrangement, buttons may be added to control direction, play, stop and other desired functions, and may be used either as an alternative to or in addition to the rollover technique described herein; an exemplary arrangement is shown in FIG. 11.

Lines (42) and (43) simply close out the code in a manner well known to those skilled in the art.

The HTML tag attributes appearing in the HTML code of Table 1, such as SRC, LANGUAGE, NAME, SHAPE, WIDTH, HEIGHT, HREF, ONMOUSEOVER, BORDER, ALT, HSPACE, VSPACE, ISMAP, USEMAP, LOWSRC and similar or corresponding HTML tag attributes, are shown in no particular order and have no specific order in which they must appear in the HTML tag. Additionally, the above pseudocode could be implemented for any image file and could use different variable names and different image map sizes and hotspots. It will also be appreciated that, although each image is associated with only one zone in the present example, the image map could be divided into more zones, for example twice the number of zones as images in the video clip, such that moving the cursor across the image map would cause two full rotations of the object. Numbers of zones which do not lead to full rotations may also be desirable in some cases. Moreover, in some embodiments it may be desirable to show motion other than rotation, and to add sound to the HTML code, so that the video clip may be an entire multimedia file which is sufficiently compact as to be emailed over even low bandwidth communications links.

The video clip files of the present invention also have the benefit that they will work with commercially available security programs which have server-side image protection among their functions. Such functionality will work to download- protect the output images in systems where the image files are called from a server with industry-standard functionality.

In a still further alternative arrangement for storing the HTML and JavaScript files and associated images of the present invention, it is also possible to use the meta tags to permit the video clips to be inserted into a relationship database management system (RDBMS) such as SQL, Oracle, Informix, or similar. Such an arrangement (see FIG. 12) permits each of a large inventory of available items to be reflected by an HTML/JavaScript description in accordance with the present invention, and also permits a web-based query to search the database server which includes the information developed in accordance with the present invention. For example, a web-based vendor maintains an online catalog of items for sales, such as parts, toys, or clothing. The online catalog is maintained as an RDBMS which can be searched by an end- user. Associated with each item in the catalog/RDBMS is an image sequence or video clip developed in accordance with the present invention. The end-user identifies the item of interest from the RDBMS, and the image file is displayed in response to the query generated from the end-user's request. The RDBMS may also include other information such as pricing, sizes, or colors, or even alternative vendors, stocking information, and so on, such that the online purchase experience is simplified and expedited, with greater resultant customer satisfaction.

The images may be simply stored in binary large object B format in a cell of the RDBMS.

At this point, the code for causing the video clip to be displayed on the users computer is now complete. In a typical arrangement, the code is then distributed to a server or other appropriate device belonging to the vendor wishing to make such video clips available to their audience of users. As noted previously, for vendors wishing to provide network access, the program code and associated will be placed on a server; for vendors wishing to provide access via CDROMs or DVDs, for example, the program code and associated images will be placed on the CDROM or DVD.

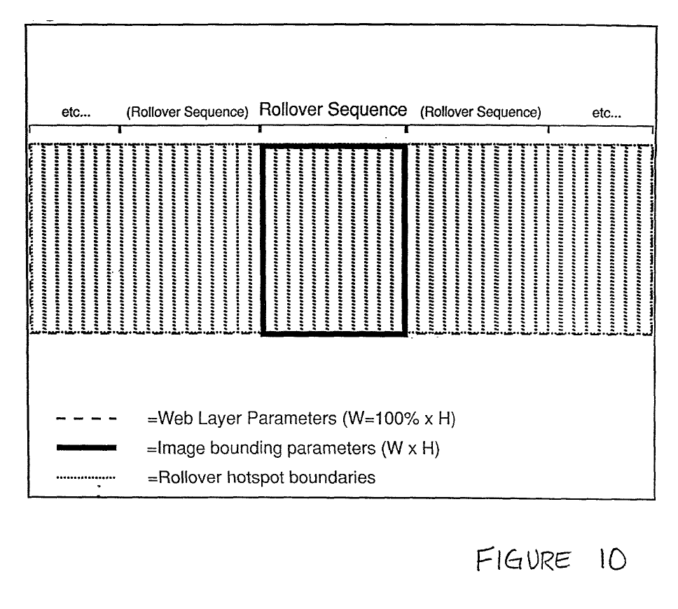

Referring next to FIG. 8, the manner by which the end user views the video clip may be better appreciated. For this example, it is assumed that the end user is connected to a server via the Internet, and is running a suitable web browser on the end user computer system. In addition, the end user is assumed to have navigated the web to the vendor's page which includes a hyperlink to the HTML file that is associated with the video clip of interest, such as that developed from the process of FIG. 2. At this point, the end user clicks on the hyperlink at step 900, which causes the browser to download the HTML file and the associated JPEG images, as shown at step 910. At step 920, the browser then extracts the script from the HTML file, and, in an exemplary arrangement although not necessarily in all instances, leaves it running continuously, which causes the first image in the video clip to be displayed. Then, in response to movement of the mouse into one of the rectangles designated by the hot spots, as shown at step 930, the browser responds at step 940 by calling the hiLite function and changing the image displayed to the image associated with the zone into which the mouse has moved. Thus, the video clip may be displayed on the end user computer simply through the use of a series of images and a rollover control, without the need for any plug-in or other conventional software download. The rollover technique is therefore simply and effective at providing sequential image displays on an end user computer without the media players or other similar software.

Turning to the fourth aspect of the present invention, there may in some environments be a desire to secure or limit the generation of video clips in accordance with the present invention. While this desire may stem from security needs, it may also stem from business model issues, in which revenue is based on the generation of video clips. Thus, the number of times computer 15 can be used to generate movies can be limited to the number of licenses that are available on computer 15. In an exemplary arrangement, in a process shown generally in FIG. 9, each license has a key that includes a pair of integers, each randomly chosen between 1 and 214748368. In other words, each integer is a random 32 bit number, so the license key has a total of 64 random bits from two random 32 bit numbers. In other embodiments, the license key could include more than two integers or only one integer. The integers could also be different sizes such as 16 bit, 64 bit, 128 bit, etc. These two random 32 bit numbers that are used in the license key are generated on a server computer that is different from the computer 15. The number of license keys that correspond to the number of licenses available on the computer 15 are stored in a file on computer 15 by the server computer. When the user generates a movie using the arrangement of the present invention, a tag having the license key is embedded in the files related to the movie and erases the license key, i.e. the two random numbers, from the file on computer 15 storing the license keys. The license key is then combined with other information to make an encrypted tag that labels the image files that compose the movie.

The other information that is used to generate the encrypted tag besides the license key is the hardware address of the computer, the name of the application's registered user, and/or other information. This data is then compressed and converted into the encrypted tag. This encrypted tag is embedded in each of the image files for the movie. A copy of the tag is also stored locally on the computer 15. The unique hardware address of the computer 15 corresponds to a network interface card in computer 15. The unique hardware address of the network interface card can be coded into the computer 15, or otherwise stored in an appropriately secure arrangement.

The user of computer 15 can have the opportunity to purchase more licenses for generating movies after the initial supply of licenses has been used. When the file on computer 15 storing the license keys is empty or nearly empty, the user will be notified that the supply of licenses available for use by the user has been exhausted or nearly exhausted. The user can then be prompted to purchase more licenses from the server computer. At the user's request, the computer 15 connects to the server computer via the Internet, direct dial-up or other similar type of connection, to purchase more licenses. The computer 15 can send any encrypted tags that have been used due to the generation of movies since the last transaction with the server computer and request the server computer to send an additional number of license keys corresponding to the number of desired licenses back to computer 15. The server computer records the purchase information for a subsequent billing of the user and generates the appropriate number license keys each having two random integers to send to the computer 15. The computer 15 then stores the received license keys in the file containing the other license keys. Alternatively, the user may transmit payment information in a secure transaction to the server computer to pay for the additional licenses. Some examples of payment information the user may send are credit card or debit card information, bank account information or information about any other similar type of payment mechanism.

Although the present invention has been described in connection with specific examples and embodiments, those skilled in the art will recognize that the present invention is capable of other variations and modifications within its scope. These examples and embodiments are intended as illustrative examples of, rather than in any way limiting on, the scope of the present invention as presented in the appended claims.

What is claimed is:

1. A method for generating multi-image video streams comprising:
providing a source of images,
selecting some but not all of the images of interest in accordance with a predetermined criteria for subsequent sequential display,
stitching together the selected images to form a sequence of images,
generating a video data stream from the selected images,
configuring the video data stream in a format displayable in a browser without the use of plug-ins.

2. The method of claim 1 wherein a video camera is used to provide a source of images.

3. The method of claim 1 wherein a series of still frame images are used to provide a source of images.

4. The method of claim 1 wherein a plurality of drawings are used to provide a source of images.

5. The method of claim 1 wherein the number of images selected is based on the total number of images in the source of images.

6. The method of claim 1 wherein the total number of images selected is based on a fixed time interval.

7. The method of claim 1 wherein the video data stream is displayed using JavaScript™.

8. The method of claim 1 wherein the source of images represents one full rotation of an object of interest.

9. A method of generating video clips suitable for downloading over the internet comprising the steps of
providing a plurality of images of a moving object,
transmitting the images as a digital data stream to an editor,
capturing the digital data stream at the editor,
parsing the digital data stream into a series of images,
assembling selected ones of the series of images into a video clip,
configuring the video clip for distribution over the internet without the use of plug-ins.

10. The method of claim 9 wherein the capturing step interfaces directly to an API.

11. The method of claim 9 further including the step of adding metadata into the video clip.

12. The method of claim 11 wherein the metadata may be used for searching.

13. The method of claim 9 wherein the editor is a personal computer.

14. A method for distributing image data to an end-user over a network comprising:
establishing a video sequence illustrating an item,
providing a database searchable by an end user,
storing the video sequence as a binary large object in a cell of the database,
displaying the video sequence when the cell wherein the sequence is stored is accessed by the end user.

15. A method for viewing sequences of images displayed in a browser window, independently of plug ins, comprising:
providing a plurality of images of an object,
establishing a window having a plurality of zones,
associating with at least a plurality of zones one of the plurality of images,
causing the image associated with each zone to be displayed when a control device moves across the associated zone.

16. The method of claim 14 wherein a sound clip associated with the video sequence is stored in a cell associated with the video clip, and is played in conjunction with the display of the video clip.

17. A digital rights management method for limiting the ability of an end-user to generate output files comprising
generating integers on a server computer
combining one or more integers with a license key
encrypting by tagging
erasing the license key.

18. The method of claim 17 wherein one license key is used for each output file generated.

19. The method of claim 15 wherein the control device is a mouse.

20. The method of claim 15 wherein the control device is a soft button on the display.
